(19) United States
(12) Patent Application Publication
(10) Pub. No.: US 2026/0017603 A1
(43) Pub. Date: Jan. 15, 2026

(54) ORDER BATCHING USING MACHINE LEARNING FOR TIMELINESS PREDICTION BASED ON FULFILLMENT LOCATION PARKING

(71) Applicant: Maplebear Inc., San Francisco, CA (US)

(72) Inventors: Christopher Billman, Chicago, IL (US); Benjamin Knight, Oakland, CA (US); Rebecca Riso, Croton-On-Hudson, NY (US); Annie Zhang, Gardena, CA (US); Radhika Anand, Redwood City, CA (US); Adam Vanderpool, Fort Worth, TX (US); Zirui Zhong, San Jose, CA (US); Kenneth Jason Sanchez, Orange, CA (US)

(21) Appl. No.: 18/770,200

(22) Filed: Jul. 11, 2024

(51) Int. Cl. G06Q 10/0836; G06Q 10/083

(52) U.S. Cl. CPC G06Q 10/0836; G06Q 10/0838

(57) ABSTRACT

An online system predicts time to park at a fulfillment location in fulfillment of an order by a fulfillment user. The online system receives an order from a requesting user, and applies a timeliness prediction model to the order, the parking configuration of the corresponding fulfillment location, to other contextual factors, or some combination thereof to predict the time to park at the fulfillment location. The timeliness prediction model is trained on historical orders with their associated completion times and known parking configurations of the respective fulfillment locations. The online system may batch orders together to optimize fulfillment efficiency in consideration of the predicted lag time for the order. The online system assigns and transmits the batches to fulfillment users to fulfill at the fulfillment locations.

### BACKGROUND

An online system receives orders from requesting users and assigns orders to fulfillment users to fulfill. The orders specify items to obtain from fulfillment locations. Fulfillment locations may have differing parking configurations which variably affect time and efforts required of fulfillment users in completing orders associated with those fulfillment locations. This variable lag time creates a technological challenge in efficient assignment for fulfillment of orders by fulfillment users.

### SUMMARY

An online system predicts lag time in order completion due to parking at fulfillment locations. The online system receives an order from a requesting user, and applies a timeliness prediction model to the order, the parking configuration of the corresponding fulfillment location, and other contextual factors to predict the time to park at the fulfillment location. The timeliness prediction model is trained on historical orders with their associated completion times and known parking configurations of the respective fulfillment locations. The online system may batch orders together to optimize fulfillment efficiency in consideration of the predicted lag time (i.e., the time to park at the fulfillment location) for the order. The online system assigns and transmits the batches to fulfillment users to fulfill at the fulfillment locations. Prediction of the lag time associated with parking at the various fulfillment locations solves the technological problem. Accordingly, the online system can assign orders to fulfillment users to maximize fulfillment efficiency despite variable lag time.

### BRIEF DESCRIPTION OF THE DRAWINGS

FIG. 1A illustrates an example system environment for an online system, in accordance with one or more embodiments.

FIG. 1B illustrates an example system environment for an online system, in accordance with one or more embodiments.

FIG. 2 illustrates an example system architecture for an online system, in accordance with one or more embodiments.

FIG. 3 is an illustrative flowchart describing prediction of time to park at a fulfillment location and order batching based on the predicted time to park, in accordance with one or more embodiments.

FIG. 4 is a method flowchart describing the process of order batching based on lag time prediction, in accordance with one or more embodiments.

### DETAILED DESCRIPTION

### Online System Environment

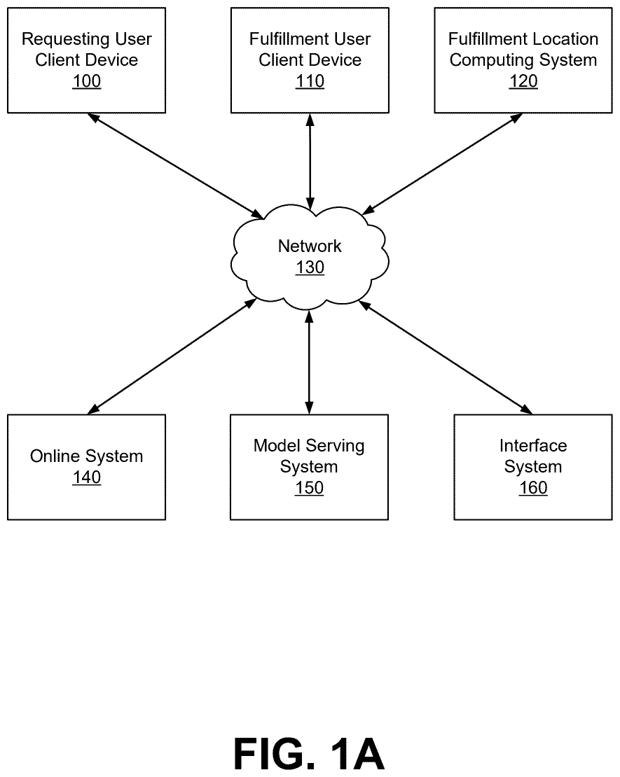

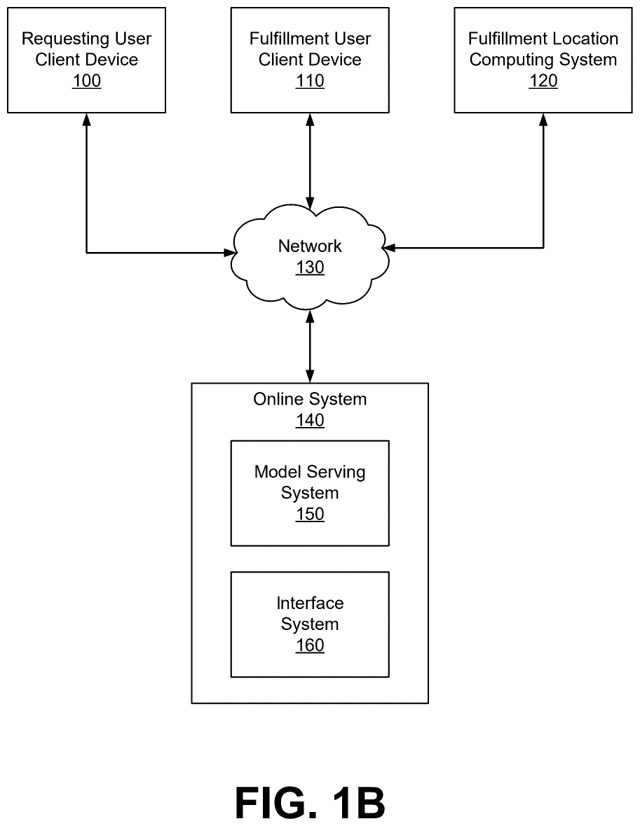

FIG. 1A illustrates an example system environment for an online system 140, in accordance with one or more embodiments. The system environment illustrated in FIG. 1A includes a requesting user client device 100, a fulfillment user client device 110, a fulfillment location computing system 120, a network 130, an online system 140, a model serving system 150, an interface system 160, and a smart cart 170. Alternative embodiments may include more, fewer, or different components from those illustrated in FIG. 1A, and the functionality of each component may be divided between the components differently from the description below. Additionally, each component may perform their respective functionalities in response to a request from a human, or automatically without human intervention.

As used herein, requesting users, fulfillment users, and fulfillment locations may be generically referred to as “users” of the online system 140. Additionally, while one requesting user client device 100, one fulfillment user client device 110, one fulfillment location computing system 120, one smart cart 170 are illustrated in FIG. 1, any number of client devices, stores, or smart carts may interact with the online system 140. As such, there may be more than one requesting user client device 100, more than one fulfillment user client device 110, more than one fulfillment location computing system 120, or more than one smart cart 170.

The requesting user client device 100 is a client device through which a requesting user may interact with the fulfillment user client device 110, the fulfillment location computing system 120, or the online system 140. The requesting user client device 100 can be a personal or mobile computing device, such as a smartphone, a tablet, a laptop computer, or desktop computer. In some embodiments, the requesting user client device 100 executes a client application that uses an application programming interface (API) to communicate with the online system 140.

A requesting user uses the requesting user client device 100 to place an order with the online system 140. A requesting user may also be referred to as a requesting user that provides orders to the online system 140 for fulfillment. An order specifies a set of items to be delivered to the requesting user. An “item,” as used herein, means a good, a product, or a service that can be provided to the requesting user through the online system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more stores from which the ordered items should be collected.

The requesting user client device 100 presents an ordering interface to the requesting user. The ordering interface is a user interface that the requesting user can use to place an order with the online system 140. The ordering interface may be part of a client application operating on the requesting user client device 100. The ordering interface allows the requesting user to search for items that are available through the online system 140. To perform a search, the requesting user provides a query (e.g., a text query, an audio query, or a visual query) to the online system 140. The online system 140 processes the query to return query results to the requesting user. Based on the displayed results, the requesting user can select which items to add to a “shopping list.” A “shopping list,” as used herein, is a tentative set of items that the user has selected for an order but that has not yet been finalized for an order. The ordering interface allows a requesting user to update the shopping list, e.g., by changing the quantity of items, adding or removing items, or adding instructions for items that specify how the item should be collected. The user interface may also include options to provide input for user preferences. For example, the requesting user may, via the user interface, provide input tagging one or more items as favorite items. In another example, the requesting user may, via the user interface, provide input (e.g., in the form of user feedback or user messages) to past orders.

The requesting user client device 100 may receive additional content from the online system 140 to present to a requesting user. For example, the requesting user client device 100 may receive coupons, recipes, or item suggestions. The requesting user client device 100 may present the received additional content to the requesting user as the requesting user uses the requesting user client device 100 to place an order (e.g., as part of the ordering interface).

Additionally, the requesting user client device 100 includes a communication interface that allows the requesting user to communicate with a fulfillment user that is servicing the requesting user's order. This communication interface allows the user to input a text-based message to transmit to the fulfillment user client device 110 via the network 130. The fulfillment user client device 110 receives the message from the requesting user client device 100 and presents the message to the fulfillment user. The fulfillment user client device 110 also includes a communication interface that allows the fulfillment user to communicate with the requesting user. The fulfillment user client device 110 transmits a message provided by the fulfillment user to the requesting user client device 100 via the network 130. In some embodiments, messages sent between the requesting user client device 100 and the fulfillment user client device 110 are transmitted through the online system 140. In addition to text messages, the communication interfaces of the requesting user client device 100 and the fulfillment user client device 110 may allow the requesting user and the fulfillment user to communicate through audio or video communications, such as a phone call, a voice-over-IP call, or a video call.

The fulfillment user client device 110 is a client device through which a fulfillment user may interact with the requesting user client device 100, the fulfillment location computing system 120, or the online system 140. The fulfillment user client device 110 can be a personal or mobile computing device, such as a smartphone, a tablet, a laptop computer, or desktop computer. In some embodiments, the fulfillment user client device 110 executes a client application that uses an application programming interface (API) to communicate with the online system 140.

The fulfillment user client device 110 receives orders from the online system 140 for the fulfillment user to service. A fulfillment user fulfills orders assigned by the online system 140, i.e., received by requesting users. Items in the order may be presented in a particular sequence (i.e., display order) to optimize efficiency of the fulfillment user. A fulfillment user services an order by collecting the items listed in the order from a store. The fulfillment user client device 110 presents the items that are included in the requesting user's order to the fulfillment user in a collection interface. The collection interface is a user interface that provides information to the fulfillment user on which items to collect for a requesting user's order and the quantities of the items. In some embodiments, the collection interface provides multiple orders from multiple requesting users for the fulfillment user to service at the same time from the same fulfillment location. The collection interface further presents instructions that the requesting user may have included related to the collection of items in the order. Additionally, the collection interface may present a location of each item at the store, and may even specify a sequence in which the fulfillment user should collect the items for improved efficiency in collecting items. In some embodiments, the fulfillment user client device 110 transmits to the online system 140 or the requesting user client device 100 which items the fulfillment user has collected in real time as the fulfillment user collects the items.

The fulfillment user can use the fulfillment user client device 110 to keep track of the items that the fulfillment user has collected to ensure that the fulfillment user collects all of the items for an order. The fulfillment user client device 110 may include a barcode scanner that can determine an item identifier encoded in a barcode coupled to an item. The fulfillment user client device 110 compares this item identifier to items in the order that the fulfillment user is servicing, and if the item identifier corresponds to an item in the order, the fulfillment user client device 110 identifies the item as collected. In some embodiments, rather than or in addition to using a barcode scanner, the fulfillment user client device 110 captures one or more images of the item and determines the item identifier for the item based on the images. The fulfillment user client device 110 may determine the item identifier directly or by transmitting the images to the online system 140. Furthermore, the fulfillment user client device 110 determines a weight for items that are priced by weight. The fulfillment user client device 110 may prompt the fulfillment user to manually input the weight of an item or may communicate with a weighing system in the fulfillment location to receive the weight of an item.

When the fulfillment user has collected all of the items for an order, the fulfillment user client device 110 instructs a fulfillment user on where to deliver the items for a requesting user's order. For example, the fulfillment user client device 110 displays a delivery location from the order to the fulfillment user. The fulfillment user client device 110 also provides navigation instructions for the fulfillment user to travel from the fulfillment location to the delivery location. When a fulfillment user is servicing more than one order, the fulfillment user client device 110 identifies which items should be delivered to which delivery location. The fulfillment user client device 110 may provide navigation instructions from the fulfillment location to each of the delivery locations. The fulfillment user client device 110 may receive one or more delivery locations from the online system 140 and may provide the delivery locations to the fulfillment user so that the fulfillment user can deliver the corresponding one or more orders to those locations. The fulfillment user client device 110 may also provide navigation instructions for the fulfillment user from the fulfillment location from which the fulfillment user collected the items to the one or more delivery locations.

In some embodiments, the fulfillment user client device 110 tracks the location of the fulfillment user as the fulfillment user delivers orders to delivery locations. The fulfillment user client device 110 collects location data and transmits the location data to the online system 140. The online system 140 may transmit the location data to the requesting user client device 100 for display to the requesting user, so that the requesting user can keep track of when their order will be delivered. Additionally, the online system 140 may generate updated navigation instructions for the fulfillment user based on the fulfillment user's location. For example, if the fulfillment user takes a wrong turn while traveling to a delivery location, the online system 140 determines the fulfillment user's updated location based on location data from the fulfillment user client device 110 and generates updated navigation instructions for the fulfillment user based on the updated location.

The tracked location may also inform progress of fulfilling an order or a batch of orders. The tracked location may provide granular insight on a completion time of order fulfillment. For example, if a fulfillment user spent a total time of one hour from order assignment to order completion (e.g., delivery), the online system 140 can use the tracked location to break down time spent completing each task, e.g., traveling to fulfillment location took 10 minutes, finding parking at the fulfillment location from arrival to the location to entering the location took 5 minutes, obtaining items in completion of the order took 40 minutes, and traveling from fulfillment location to delivery location took 15 minutes.

The fulfillment user client device 110 may also provide a communication interface to the fulfillment user, e.g., to communicate with another user of the online system 140. For example, the communication interface of the fulfillment user client device 110 may present messages from a requesting user client device 100 to the fulfillment user client device 110. Such communication may be utilized when items in an order are unavailable at the fulfillment location. In such scenarios, the fulfillment user may query the requesting user for suitable substitution items to be obtained for the unavailable item. The messages may be in the form of text, audio, pictures, other digital manners of communicating information, etc.

In one or more embodiments, the fulfillment user is a single person who collects items for an order from a fulfillment location and delivers the order to the delivery location for the order. Alternatively, more than one person may serve the role as a fulfillment user for an order. For example, multiple people may collect the items at the fulfillment location for a single order. Similarly, the person who delivers an order to its delivery location may be different from the person or people who collected the items from the fulfillment location. In these embodiments, each person may have a fulfillment user client device 110 that they can use to interact with the online system 140.

Additionally, while the description herein may primarily refer to fulfillment users as humans, in some embodiments, some or all of the steps taken by the fulfillment user may be automated. For example, a semi-or fully-autonomous robot may collect items in a fulfillment location for an order and an autonomous vehicle may deliver an order to a requesting user from a fulfillment location.

The fulfillment location computing system 120 is a computing system operated by a fulfillment location that interacts with the online system 140. As used herein, a “fulfillment location” is an entity that operates a physical location storing items, e.g., which may be a store, warehouse, or other physical building from which a fulfillment user can collect items. The fulfillment location computing system 120 stores and provides item data to the online system 140 and may regularly update the online system 140 with updated item data. For example, the fulfillment location computing system 120 provides item data indicating which items are available at a particular fulfillment location and the quantities of those items. Additionally, the fulfillment location computing system 120 may transmit updated item data to the online system 140 when an item is no longer available at the fulfillment location. Additionally, the fulfillment location computing system 120 may provide the online system 140 with updated item prices, sales, or availabilities. Additionally, the fulfillment location computing system 120 may receive payment information from the online system 140 for orders serviced by the online system 140. Alternatively, the fulfillment location computing system 120 may provide payment to the online system 140 for some portion of the overall cost of a user's order (e.g., as a commission).

The fulfillment location computing system 120 may provide the online system 140 with store data describing the store associated with the fulfillment location computing system 120. The store data may include store name, store address, store website, store phone number, other identifying information, a type of store, an expense class of the store (e.g., $, $$, or $$$), opening hours, general dependability of items, diversity of items, types of items carried, or information describing the store, or some combination thereof. In some embodiments, the fulfillment location computing system 120 may provide location-specific features describing characteristics of the physical location of the fulfillment location, e.g., parking configuration, in-store layout, in-store accessibility, etc. The online system 140 may further infer additional store data based on interactions between requesting users or fulfillment users and the store. For example, such store data based on the interactions may include requesting user reviews, fulfillment user reviews, popular items ordered, dependability of items, etc.

The requesting user client device 100, the fulfillment user client device 110, the fulfillment location computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which requesting users can order items to be provided to them by a fulfillment user from a store. The online system 140 receives orders from a requesting user client device 100 through the network 130. The online system 140 selects a fulfillment user to service the requesting user's order and transmits the order to a fulfillment user client device 110 associated with the fulfillment user. The fulfillment user collects the ordered items from a fulfillment location and delivers the ordered items to the requesting user. The online system 140 may charge a requesting user for the order and provide portions of the payment from the requesting user to the fulfillment user and the store.

As an example, the online system 140 may allow a requesting user to order groceries from a grocery store. The requesting user's order may specify which groceries they want delivered from the grocery store and the quantities of each of the groceries. The requesting user's client device 100 transmits the requesting user's order to the online system 140 and the online system 140 selects a fulfillment user to travel to the grocery fulfillment location to collect the groceries ordered by the requesting user. Once the fulfillment user has collected the groceries ordered by the requesting user, the fulfillment user delivers the groceries to a location transmitted to the fulfillment user client device 110 by the online system 140.

The model serving system 150 receives requests from the online system 140 to perform tasks using machine-learned models. The tasks include, but are not limited to, natural language processing (NLP) tasks, audio processing tasks, image processing tasks, video processing tasks, and the like. In one or more embodiments, the machine-learned models deployed by the model serving system 150 are language models configured to perform one or more NLP tasks. The NLP tasks include, but are not limited to, text generation, query processing, machine translation, chatbots, and the like. In one or more embodiments, a language model of the model serving system 150 is configured as a transformer neural network architecture (i.e., a transformer model). Specifically, the transformer model is coupled to receive sequential data tokenized into a sequence of input tokens and generates a sequence of output tokens depending on the task to be performed.

The model serving system 150 receives a request including input data (e.g., text data, audio data, image data, or video data) and encodes the input data into a set of input tokens. The model serving system 150 applies the machine-learned model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine-learned model is a language model, the sequence of input tokens or output tokens are arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one or more embodiments, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many tasks. The language model can be configured as any other appropriate architecture including, but not limited to, transformer-based networks, long short-term memory (LSTM) networks, Markov networks, BART, generative-adversarial networks (GAN), diffusion models (e.g., Diffusion-LM), and the like.

In one or more embodiments, the task for the model serving system 150 is based on knowledge of the online system 140 that is fed to the machine-learned model of the model serving system 150, rather than relying on general knowledge encoded in the model weights of the model. Thus, one objective may be to perform various types of queries on the external data in order to perform any task that the machine-learned model of the model serving system 150 could perform. For example, the task may be to perform question-answering, text summarization, text generation, and the like based on information contained in an external dataset.

Thus, in one or more embodiments, the online system 140 is connected to an interface system 160. The interface system 160 receives external data from the online system 140 and builds a structured index over the external data using, for example, another machine-learned language model or heuristics. The interface system 160 receives one or more queries from the online system 140 on the external data. The interface system 160 constructs one or more prompts for input to the model serving system 150. A prompt may include the query of the user and context obtained from the structured index of the external data. In one instance, the context in the prompt includes portions of the structured indices as contextual information for the query. The interface system 160 obtains one or more responses from the model serving system 150 and synthesizes a response to the query on the external data. While the online system 140 can generate a prompt using the external data as context, often times, the amount of information in the external data exceeds prompt size limitations configured by the machine-learned language model. The interface system 160 can resolve prompt size limitations by generating a structured index of the data and offers data connectors to external data sources.

FIG. 1B illustrates an example system environment for an online system 140, in accordance with one or more embodiments. The system environment illustrated in FIG. 1B includes a requesting user client device 100, a fulfillment user client device 110, a fulfillment location computing system 120, a network 130, an online system 140, and a smart cart 170. Alternative embodiments may include more, fewer, or different components from those illustrated in FIG. 1B, and the functionality of each component may be divided between the components differently from the description below. Additionally, each component may perform their respective functionalities in response to a request from a human, or automatically without human intervention.

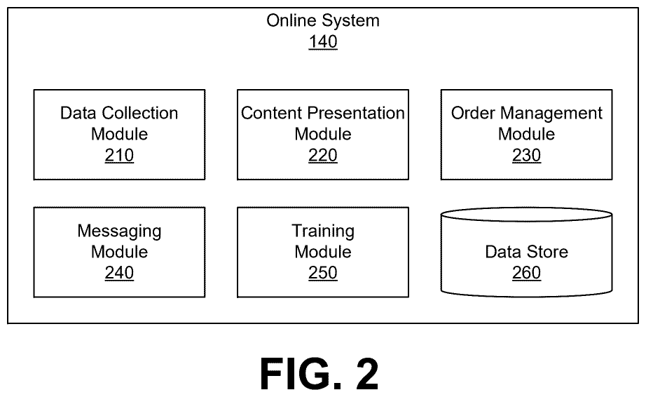

The example system environment in FIG. 1A illustrates an environment where the model serving system 150 and/or the interface system 160 is managed by a separate entity from the online system 140. In one or more embodiments, as illustrated in the example system environment in FIG. 1B, the model serving system 150 and/or the interface system 160 is managed and deployed by the entity managing the online system 140. The online system 140 is described in further detail below with regards to FIG. 2.

### Online System Architecture

FIG. 2 illustrates an example system architecture for an online system 140, in accordance with some embodiments. The system architecture illustrated in FIG. 2 includes a data collection module 210, a content presentation module 220, an order management module 230, a messaging module 240, a training module 250, and a data store 260. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 210 collects data used by the online system 140 and stores the data in the data store 260. The data collection module 210 may only collect data describing a user if the user has previously explicitly consented to the online system 140 collecting data describing the user. Additionally, the data collection module 210 may encrypt all data, including sensitive or personal data, describing users.

For example, the data collection module 210 collects requesting user data, which is information or data that describe characteristics of a requesting user. For example, the data collection module 210 may collect a requesting user's name, address, other demographic information (e.g., age range, family size, dietary restrictions or preferences, etc.), preferences (e.g., store visit frequency, order magnitude, etc.), previous orders, favorite items, favorite types of items, favorite stores, favorite fulfillment users, repeat fulfillment users, stored payment instruments, or some combination thereof. The requesting user data also may include default settings established by the requesting user, such as a default store/fulfillment location, payment instrument, delivery location, or delivery timeframe. The requesting user data may also include user preference data indicating one or more preferences, e.g., provided by the user and/or inferred by the online system 140. The data collection module 210 may collect the requesting user data from sensors on the requesting user client device 100 or based on the requesting user's interactions with the online system 140.

The data collection module 210 also collects item data, which is information or data that identifies and describes items that are available at a fulfillment location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the dependability of items in fulfillment locations, also referred to as “dependability.” For example, for each item- store combination (a particular item at a particular warehouse), the item data may include a time that the item was last found, a time that the item was last not found (a fulfillment user looked for the item but could not find it), the rate at which the item is found, or the popularity of the item. The data collection module 210 may collect item data from a fulfillment location computing system 120, a fulfillment user client device 110, or the requesting user client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 210 also collects fulfillment user data, which is information or data that describes characteristics of fulfillment users. For example, the data collection module 210 may collect the fulfillment user's name, the fulfillment user's location, how often the fulfillment user has serviced orders for the online system 140, a requesting user rating for the fulfillment user, a number of requesting users that have favorited the fulfillment user, which stores the fulfillment user has collected items at, or the fulfillment user's previous shopping history. Additionally, the fulfillment user data may include preferences expressed by the fulfillment user, such as their preferred stores to collect items at, how far they are willing to travel to deliver items to a requesting user, how many items they are willing to collect at a time, timeframes within which the fulfillment user is willing to service orders, payment information by which the fulfillment user is to be paid for servicing orders (e.g., a bank account), feedback from the fulfillment user in fulfilling requesting user orders, etc. The data collection module 210 collects fulfillment user data from sensors of the fulfillment user client device 110 or from the fulfillment user's interactions with the online system 140.

Additionally, the data collection module 210 collects order data, which is information or data that describes characteristics of an order. For example, order data may include item data for items that are included in the order, a delivery location for the order, a requesting user associated with the order, a fulfillment location from which the requesting user wants the ordered items collected, or a timeframe within which the requesting user wants the order delivered. Order data may further include information describing how the order was serviced, such as which fulfillment user serviced the order, when the order was delivered, or a rating that the requesting user gave the delivery of the order. In some embodiments, the order data includes user data for users associated with the order, such as requesting user data for a requesting user who placed the order or fulfillment user data for a fulfillment user who serviced the order.

The data collection module 210 may also collect data relating to completion and/or feedback related to an order. For example, the data collection module 210 may receive confirmation from a fulfillment user client device 100 that an order was completed. The data collection module 210 may determine the completion time from order assignment to confirmation of order completion. The data collection module 210 may also receive tracked location of the fulfillment user client device 110, e.g., which it may use to parse time elapsed per task. Feedback on each order may be received from the requesting user client device 100 and/or the fulfillment user client device 110. For example, the requesting user client device 100 may provide feedback on items obtained in fulfillment of the order, order timeliness, responsiveness of the fulfillment user to inquiries, replacement workflow, etc. The fulfillment user client device 110 may provide feedback on difficulty in completing order, difficulty in parking and/or other location accessibility issues, responsiveness of the requesting user, etc.

The data collection module 210 may also collect data from the fulfillment location computing systems 130. For example, the data collection module 210 may collect information on order volume, user foot traffic, metrics relating to order completion times, metrics relating to time spent by patrons generally at the fulfillment location, parking configuration of the location, accessibility of the location (e.g., walkways, stairways, elevators, escalators, size, etc.), etc. The parking configuration may describe (1) whether the fulfillment location has a patron-restricted parking area, (2) if so, how many spots are available, (3) if there is public parking in proximity to the location, (4) if so, how many spots are available, (5) a distance to the location from the public parking spots, (6) other parking-related issues, or some combination thereof. Such information may, alternatively, be provided by one or more of the client devices, e.g., the requesting user client device 100 or the fulfillment user client device 110. For example, the fulfillment user client device 110 may provide information on the parking configuration, e.g., indicating how many patron-restricted spots are available, difficulty in finding parking, etc.

The content presentation module 220 selects content for presentation to a user. For example, the content presentation module 220 selects which items to present to a requesting user while the requesting user is placing an order and/or using a smart cart during an in-store visit.

In embodiments with the requesting user placing an order, the content presentation module 220 generates and transmits an ordering interface for the requesting user to order items. The content presentation module 220 populates the ordering interface with items that the requesting user may select for adding to their order. In some embodiments, the content presentation module 220 presents a catalog of all items that are available to the requesting user, which the requesting user can browse to select items to order. The content presentation module 220 also may identify items that the requesting user is most likely to order and present those items to the requesting user. For example, the content presentation module 220 may score items and rank the items based on their scores. The content presentation module 220 displays the items with scores that exceed some threshold (e.g., the top n items or the p percentile of items).

The content presentation module 220 may use a scoring function to score items for presentation to a requesting user. The scoring function may score items for a requesting user based on item data for the items and requesting user data for the requesting user. The scoring function may determine a ranking score based on ranking parameter values for each item and a weight vector. In some embodiments, an item selection model trained as a machine-learning model may determine a likelihood that the requesting user will order the item. In some embodiments, the item selection model uses item embeddings describing items and requesting user embeddings describing requesting users to score items. These item embeddings and requesting user embeddings may be generated by separate machine-learning models and may be stored in the data store 260.

The order management module 230 manages orders by requesting users. The order management module 230 receives orders from one or more requesting user client devices 100 and assigns the orders to fulfillment users, e.g., via their fulfillment user client devices 110, for fulfillment. The order management module 230 may assign the orders to fulfillment users based on the fulfillment user data. For example, the order management module 230 assigns an order to a fulfillment user based on the fulfillment user's location and the location of the store from which the ordered items are to be collected. The order management module 230 may also assign an order to a fulfillment user based on how many items are in the order, a vehicle operated by the fulfillment user, the delivery location, a lag time predicted for completing the order, the fulfillment user's preferences on how far to travel to deliver an order, the fulfillment user's ratings by requesting users, or how often a fulfillment user agrees to service an order. In some embodiments, the order management module 230 may batch orders together for fulfillment by one fulfillment user. For example, the order management module 230 may batch orders based on an order requested timestamp, fulfillment locations indicated in an order, lag time predicted in completing an order, delivery time, travel distance, etc.

In some embodiments, the order management module 230 determines when to assign an order to a fulfillment user based on a delivery timeframe requested by the requesting user with the order. The order management module 230 computes an estimated amount of time that it would take for a fulfillment user to collect the items for an order and deliver the ordered items to the delivery location for the order. The order management module 230 assigns the order to a fulfillment user at a time such that, if the fulfillment user immediately services the order, the fulfillment user is likely to deliver the order at a time within the requested timeframe. Thus, when the order management module 230 receives an order, the order management module 230 may delay in assigning the order to a fulfillment user if the requested timeframe is far enough in the future (i.e., the fulfillment user may be assigned at a later time and is still predicted to meet the requested timeframe).

In some embodiments, the order management module 230 applies a timeliness prediction model to predict a completion time of an order. In one or more embodiments, the timeliness prediction model inputs order features describing the order, contextual features describing context of the order, or some combination thereof. The order features may include number of items in the order, fulfillment location associated with the order, time of order, urgency of order, etc. The contextual features provide additional context around the order. The contextual features may include location-specific features associated with the fulfillment location, time-specific features associated with the time of the order, other features describing a context of the order, the requesting user, the fulfillment location, the items, etc. The location-specific features describe the fulfillment location and may be provided by the fulfillment location computing system 130. For example, the location-specific features may include a parking configuration of the fulfillment location, foot traffic data of users (e.g., during different hours of the day, during different days of the week, during different periods in the year, etc.), order volume at that fulfillment location, other accessibility characteristics, etc. The time-specific features may include order volume of the online system 140 (e.g., during different hours of the day, during different days of the week, during different periods in the year, etc.), number of fulfillment users scheduled and/or presently available to fulfill orders, etc.

The order management module 230 inputs the features into the timeliness prediction model which outputs a predicted completion time for completing the order (also referred to as a “time for completion”). In some embodiments, the timeliness prediction model may also be configured to output a breakdown of the predicted completion time, i.e., breaking down predicted amounts of time for completing tasks to completing the order. For example, the timeliness prediction model may predict 10 minutes for parking (upon arrival to the fulfillment location), 30 minutes for obtaining items in the order, and 5 minutes for checkout, etc.

In other embodiments, the timeliness prediction model may be configured to output a default completion time (e.g., based on the order features and, optionally, agnostic of the fulfillment location) and a lag time indicating additional time to complete the order based on the contextual features (e.g., based on the parking configuration, time of day, etc.). For example, the timeliness prediction model may output the default completion time for orders of similar size (e.g., 30 minutes to obtain 20 items) and the lag time for a particular fulfillment location, i.e., a time to park at the particular fulfillment location (e.g., 15 minutes to park on street and walk to entrance). In other embodiments, the timeliness prediction model may directly predict the time to park at the particular fulfillment location, e.g., based on order features, parking configuration, other contextual features, or some combination thereof. In some embodiments, the timeliness prediction model may output multiple completion times for different modes of travel, e.g., a first completion time for a fulfillment user traveling by multi-seater motor vehicle, a second completion time for a fulfillment user traveling by single-seater motor vehicle, and a third completion time for a fulfillment user traveling by a self-powered vehicle.

In one or more embodiments, the order management module 230 may batch orders or assign orders based in part on the predicted completion time. The predicted completion time may be a number, a range of numbers, or a gradation of timeliness (e.g., on-time, slight delay, delayed). The order management module 230 may apply a batching model that batches orders together based in part on the predicted completion time. Other inputs to the model may include: size of order, requested delivery time, delivery address, fulfillment location associated with the order, other order features, availability of fulfillment users, capacity of individual fulfillment users, other contextual features, etc. In one or more embodiments, the batching model may be a machine-learning model trained to optimize efficiency in fulfillment of batched orders. The batched orders may be transmitted to fulfillment user client devices 110 to fulfill respective batches of orders. In one or more embodiments, the order management module 230 may assign an order, e.g., based on predicted completion time, to a fulfillment user in the middle of completing a batch, i.e., adding an order to the batch midway. This may be advantageous in situations where a fulfillment user may be already located at the particular fulfillment location.

In other embodiments, the order management module 230 may perform one or more other actions based on the predicted completion times. In some embodiments, the order management module 230 may adjust possible delivery times in the ordering interface to give a more accurate timeframe for a requesting user to anticipate arrival of an order. For example, as a requesting user selects a fulfillment location and begins adding items, the order management module 230 may apply the timeliness prediction model to predict a time for completion of the tentative order (as the order has yet to be placed), a time to park at the fulfillment location, or some combination thereof. The ordering interface may display the predicted time for completion of the tentative order, to provide real-time feedback on the timely completion of the order. Or, in other examples, the ordering interface may restrict one or more delivery timeframes based on the predicted time for completion. For example, if the order is predicted to have a time for completion of one hour, the ordering interface would remove an option for delivery in 30 minutes from ordering. The ordering interface may automatically re-predict the completion time as the tentative order is changed, which can provide real-time feedback on the fulfillment efficiency of tentative orders.

In some embodiments, the order management module 230 may reflect the predicted completion time in one or more incentives to a fulfillment user or one or more charges to the requesting user. The order management module 230 may assess a loss in efficiency in fulfilling a particular order based on the predicted completion time. The loss in efficiency may be based on a lag time due to circumstances (e.g., the lag time may be calculated as a difference between the predicted completion time and an expected completion time for like orders). For example, the order management module 230 may calculate the loss in efficiency due to a difficult parking configuration at a particular fulfillment location. The order management module 230 may determine the one or more incentives to further incentivize fulfillment users to accept the order, and/or the one or more charges to the requesting user of the order. The order management module 230 may automatically display the one or more incentives on an interface for the fulfillment users and/or the charges on the ordering interface for the requesting user.

In some embodiments, the order management module 230 may use the predicted completion time to subdivide an order into multiple tasks that can be each tackled by separate entities. For example, the order management module 230 may, based on predicted completion times of one or more orders at one fulfillment location, determine that the fulfillment location has a particularly frictional parking configuration that consistently yields order lag times above some threshold. The order management module 230 may, in response to determining that the fulfillment location has the frictional parking configuration, can subdivide one order into: (1) item obtainment, as one task to be completed by one user; and (2) order pickup and delivery, as a second task to be completed by another user. Such subdivision dissociates the need for one user to both park, then obtain items in the fulfillment location.

In other embodiments, the order management module 230 may leverage insights from the predicted completion times at particular fulfillment locations to request modifications to the parking configuration by the fulfillment location. The order management module 230 may request that one or more spots of a patron-restricted parking lot be designated for fulfillment users of the online system 140.

When the order management module 230 assigns an order to a fulfillment user, the order management module 230 transmits the order to the fulfillment user client device 110 associated with the fulfillment user, e.g., with the content presentation module 220. The order management module 230 may also transmit navigation instructions from the fulfillment user's current location to the fulfillment location associated with the order. If the order includes items to collect from multiple fulfillment locations, the order management module 230 identifies the fulfillment locations to the fulfillment user and may also specify a sequence in which the fulfillment user should visit the fulfillment locations.

The order management module 230 may track the location of the fulfillment user through the fulfillment user client device 110 to determine when the fulfillment user arrives at the fulfillment location. When the fulfillment user arrives at the fulfillment location, the order management module 230 transmits the order to the fulfillment user client device 110 for display to the fulfillment user. As the fulfillment user uses the fulfillment user client device 110 to collect items at the fulfillment location, the order management module 230 receives item identifiers for items that the fulfillment user has collected for the order. In some embodiments, the order management module 230 receives images of items from the fulfillment user client device 110 and applies computer-vision techniques to the images to identify the items depicted by the images. The order management module 230 may track the progress of the fulfillment user as the fulfillment user collects items for an order and may transmit progress updates to the requesting user client device 100 that describe which items have been collected for the requesting user's order.

The order management module 230 determines when the fulfillment user has collected all of the items for an order. For example, the order management module 230 may receive a message from the fulfillment user client device 110 indicating that all of the items for an order have been collected. Alternatively, the order management module 230 may receive item identifiers for items collected by the fulfillment user and determine when all of the items in an order have been collected. When the order management module 230 determines that the fulfillment user has completed an order, the order management module 230 transmits the delivery location for the order to the fulfillment user client device 110. The order management module 230 may also transmit navigation instructions to the fulfillment user client device 110 that specify how to travel from the fulfillment location to the delivery location, or to a subsequent fulfillment location for further item collection. The order management module 230 tracks the location of the fulfillment user as the fulfillment user travels to the delivery location for an order, and updates the requesting user with the location of the fulfillment user so that the requesting user can track the progress of the order. In some embodiments, the order management module 230 computes an estimated time of arrival of the fulfillment user at the delivery location and provides the estimated time of arrival to the requesting user.

The order management module 230 coordinates payment by the requesting user for the order. The order management module 230 uses payment information provided by the requesting user (e.g., a credit card number or a bank account) to receive payment for the order. In some embodiments, the order management module 230 stores the payment information for use in subsequent orders by the requesting user. The order management module 230 computes a total cost for the order and charges the requesting user that cost. The order management module 230 may provide a portion of the total cost to the fulfillment user for servicing the order, and another portion of the total cost to the store. The order management module 230 may further provide an option to the requesting user to provide a tip to the fulfillment user, e.g., for outstanding service.

The messaging module 240 facilitates communication between the requesting user client device 100 and the fulfillment user client device 110. As noted above, a requesting user may use a requesting user client device 100 to send a message to the fulfillment user client device 110. The messaging module 240 receives the message from the requesting user client device 100 and transmits the message to the fulfillment user client device 110 for presentation to the fulfillment user. The fulfillment user may use the fulfillment user client device 110 to send a message to the requesting user client device 100 in a similar manner. Communications between the requesting user and the fulfillment user may be provided to the content presentation module 220 in scoring items for a requesting user.

The training module 250 trains machine-learning models used by the online system 140. For example, the training module 250 may train an item selection model, a dependability model, one or more query processing models, a timeliness prediction model, a batching model, or any of the machine-learned models deployed by the model serving system 150. The online system 140 may use machine-learning models to perform functionalities described herein. Example machine-learning models include regression models, support vector machines, naïve bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, or transformers. A machine-learning model may include components relating to these different general categories of model, which may be sequenced, layered, or otherwise combined in various configurations.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The training module 250 generates the set of parameters (e.g., the particular values of the parameters) for a machine-learning model by “training” the machine-learning model. Once trained, the machine-learning model uses the set of parameters to transform inputs into outputs.

The training module 250 trains a machine-learning model based on a set of training examples. Each training example includes input data to which the machine-learning model is applied to generate an output. For example, each training example may include requesting user data, fulfillment user data, item data, or order data. In some cases, the training examples also include a label which represents an expected output of the machine-learning model. In these cases, the machine-learning model is trained by comparing its output from input data of a training example to the label for the training example. In general, during training with labeled data, the set of parameters of the model may be set or adjusted to reduce a difference between the output for the training example (given the current parameters of the model) and the label for the training example.

The training module 250 may apply an iterative process to train a machine-learning model whereby the training module 250 updates parameter values of the machine-learning model based on each of the set of training examples. The training examples may be processed together, individually, or in batches. To train a machine-learning model based on a training example, the training module 250 applies the machine-learning model to the input data in the training example to generate an output based on a current set of parameter values. The training module 250 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross-entropy loss function. The training module 250 updates the set of parameters for the machine-learning model based on the score generated by the loss function. For example, the training module 250 may apply gradient descent to update the set of parameters.

In one or more embodiments, the training module 250 may train the timeliness prediction model on historical orders. The data collection module 210 may track completion time of the historical orders. In some embodiments, the data collection module 210 may track a physical location of the fulfillment user during fulfillment of an order to apportion a subset of the completion time to the performance of various tasks. The training module 250 may further retrieve location-specific features of the fulfillment location associated with each historical order. The training module 250 may train the timeliness prediction model with the historical data, e.g., to predict overall completion time, and/or to, more specifically, predict lag time (e.g., attributable to parking configuration of a fulfillment location).

In one or more embodiments, the training module 250 may train the batching model for batching orders together. The training module 250 may obtain historical orders and other metrics related to the historical orders (e.g., completion time). The training module 250 may score the fulfillment efficiency of batches based on their completion times. The fulfillment efficiency may be based on the overall completion time of the batch, the completion time of each order in the batch, other metrics relating to the batch and/or each order, or some combination thereof. Based on the scores, the training module 250 may train the batching model to optimize fulfillment efficiency across batches.

The data store 260 stores data used by the online system 140. For example, the data store 260 stores requesting user data, store data, item data, order data, and fulfillment user data for use by the online system 140. The data store 260 also stores trained machine-learning models trained by the training module 250. For example, the data store 260 may store the set of parameters for a trained machine-learning model on one or more non-transitory, computer-readable media. The data store 260 uses computer-readable media to store data, and may use databases to organize the stored data.

With respect to the machine-learned models hosted by the model serving system 150, the machine-learned models may already be trained by a separate entity from the entity responsible for the online system 140. In one or more other embodiments, when the model serving system 150 is included in the online system 140, the training module 250 may further train parameters of the machine-learned model based on data specific to the online system 140 stored in the data store 260. As an example, the training module 250 may obtain a pre-trained transformer language model and further fine-tune the parameters of the transformer model using training data stored in the data store 260. The training module 250 may provide the model to the model serving system 150 for deployment.

### Order Batching Based on Parking-Informed Timeliness Prediction

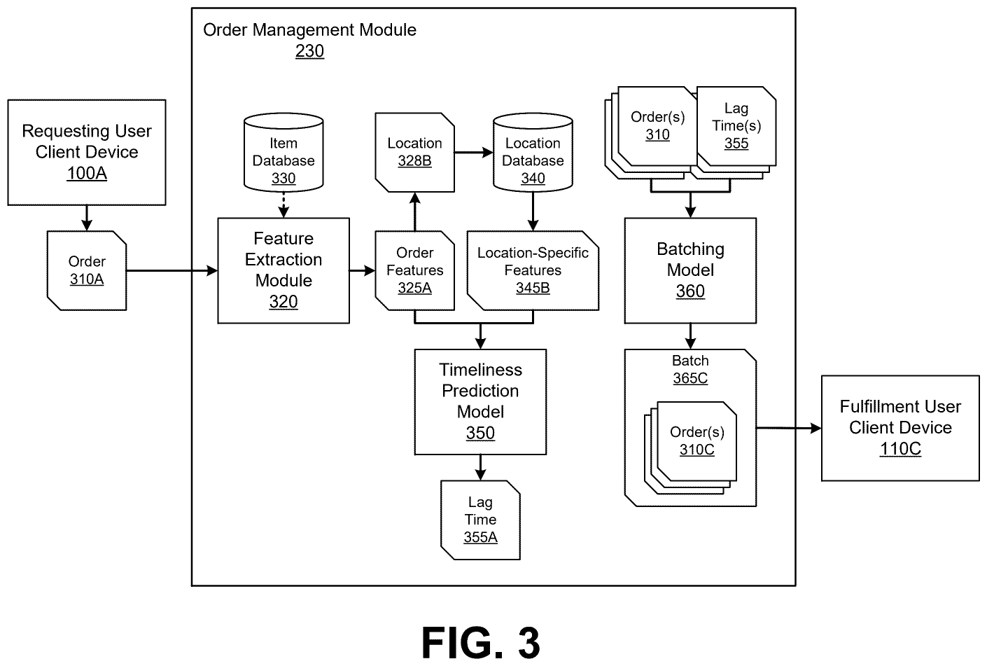

FIG. 3 is an illustrative flowchart describing prediction of time to park at a fulfillment location and order batching based on the predicted time to park, in accordance with one or more embodiments. The flowchart is illustrative in representing the interaction between requesting user client device 100A, the order management module 230 of the online system 140, and the fulfillment user client device 110C. In other embodiments, any computing system or device may perform any, some, or all of the steps.

The requesting user client device 100A provides an order 310A to the order management module 230 of the online system 140 (e.g., via an order interface presented by the content presentation module 220). The order management module 230 may include a feature extraction module 320 that extracts order features 325A from the order 310A. The order features 325A describe the order, including time of order (e.g., a timestamp), a fulfillment location 328B to obtain the items from, number of items, etc. The feature extraction module 320 may extract the order features 325A leveraging data from the item database 330 storing the items available for ordering with the online system 140. The feature extraction module 320 may further obtain contextual features to the order 310A that describe a context of the order. In one or more embodiments, the feature extraction module 320 extracts, as contextual features, location-specific features 345B describing the fulfillment location 328A associated with the order 310A. The location-specific features 345B may be stored in a location database 340. The location-specific features 345B for the location 328B may include a parking configuration at the fulfillment location 328B.

The timeliness prediction model 350 inputs the order features 325A, the location-specific features 345B, or some combination thereof to output a timeliness prediction for the order 310A, e.g., a lag time 355A. The timeliness prediction model may, in other examples, output a completion time for completing fulfillment of the order 310A, i.e., from time of placing the order 310A to physical receipt of items in the order 310A (or some other terminal condition, e.g., delivery to appointed address). The timeliness prediction model 350 may be trained as a machine-learning model with training data. In one or more embodiments, the timeliness prediction model 350 predicts the lag time 355A attributable to the location-specific features 345B (e.g., the parking configuration) of the fulfillment location 328B. The lag time 335A may indicate a predicted time to park at the fulfillment location 328B.

The order management module 230 may perform one or more remedial actions in response to the lag time prediction. In some embodiments, the order management module 230 may implement a remedial workflow in response to determining that an order's lag time is above a threshold lag time. In some embodiments, the order management module 230 batches orders 310 together based on their lag times 355. A batching model 360 inputs the orders 310 and their associated lag times 355 (e.g., predicted by the timeliness prediction model 350) to determine optimal batches 365. The batches are then assigned to fulfillment users. In the illustration shown, the batching model 360 outputs batch 365C inclusive of orders 310C, and assigns the batch 365C to the fulfillment user client device 110C.

In other embodiments, the order management module 230 may perform other remedial actions in the remedial workflow. For example, the order management module 230 may include one or more incentives for fulfillment users or charges to requesting users. In another example, the order management module 230 may present the predicted lag time 355A for an order 310A to the requesting user client device 110A. In such examples, the ordering interface may adjust available delivery timeframes based on the predicted lag time 355A for the order 310A.

### Example Methods

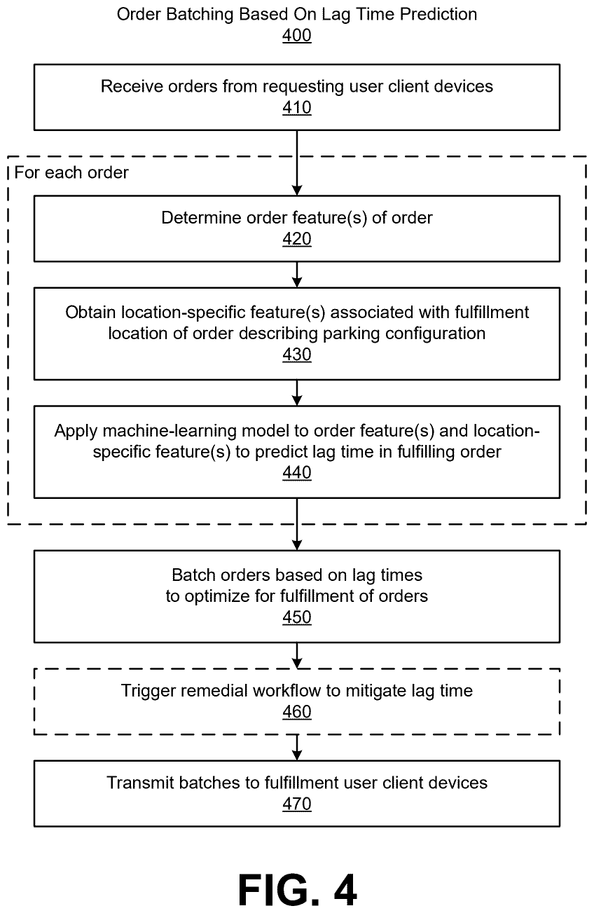

FIG. 4 is a method flowchart describing the process 400 of order batching based on lag time prediction, in accordance with one or more embodiments. The description of FIG. 4 is in the perspective of an online system (e.g., the online system 140), but in other embodiments, any computing system or device may perform any, some, or all of the steps.

The online system receives 410 orders from requesting user client devices. The orders may indicate items to obtain from fulfillment locations. The online system may record a timestamp with each received order. In some embodiments, the online system may preemptively predict lag time associated with a tentative order, e.g., via an ordering interface presented on the requesting user client devices. This provides real-time updates to delivery timeframes.

The online system may predict a lag time for each order. To predict the lag time, the online system determines 420 order features that describe the order. Such order features may include items ordered, timestamp of the order, the fulfillment location to obtain items from, etc. The online system obtains 430 location-specific features associated with the fulfillment location identified in the order. The location-specific features may be agnostic to the order. The location-specific features may include parking configuration of the fulfillment location, e.g., describing whether there is patron-exclusive parking, whether there is public parking, how many spots of each type of parking, whether there are charges associated with parking, whether there are timing restrictions, etc. The online system may extract other contextual features describing a context of the order, e.g., time of day, order volume through the online system, order volume at the fulfillment location, etc. The online system applies 440 a machine-learning model to the order features and the location-specific features (and, optionally, to any other contextual features) to predict a lag time in fulfilling the order. In some embodiments, the machine-learning model may further output a completion time, which accounts for a default completion time and the lag time. In some embodiments, the machine-learning model may output a set of lag times (or completion times) for different modes of transportation of fulfillment users (e.g., walking, self-powered vehicle, single-seater motor vehicle, multi-seater motor vehicle, etc.).

The online system batches 450 orders based on the lag times to optimize for fulfillment of the orders. The online system may batch the orders based at least in part on the lag times, but may also batch according to order features, other contextual features, etc. The online system may apply another machine-learning model to perform the batching. In some embodiments, batching may entail assigning an order to an in-progress batch. For example, a fulfillment user is located at a fulfillment location fulfilling an in-progress batch. The online system receives another order (not initially in the batch) and predicts the lag time due to the parking configuration at the fulfillment location. In response to determining that the lag time is above a threshold, the online system may assign the order to the fulfillment user already located at the fulfillment location rather than assigning the order to another fulfillment user not presently located at the fulfillment location. Or, in other embodiments, the online system may assign the order to a fulfillment user with a mode of transportation that can mitigate the lag time (e.g., walking, self-powered vehicle, single-seater motor vehicle, etc.). In some embodiments, the online system may split up tasks for an order, e.g., assign item obtainment to one fulfillment user positioned at the fulfillment location and assign order pickup and delivery to another fulfillment user so that the second user need not spend time parking.

The online system may further trigger 460 a remedial workflow to further mitigate lag time. If a lag time is above the threshold, the remedial workflow may be triggered. The remedial workflow may include one or more remedial actions. Remedial actions may include adding one or more incentives to fulfillment users, adding one or more charges to the requesting user, requesting designated parking from the fulfillment location, etc.

The online system transmits 470 the batches of orders to fulfillment user client devices. The online system may collect metrics relating to fulfillment of the batches, e.g., for training the machine-learning models. The online system may also collect feedback from users, e.g., the requesting users and/or the fulfillment users, which may also be used in training the machine-learning models.

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor may comprise one or more subprocessing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated for the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

1. A method, performed by a computer system comprising a processor and a non-transitory computer-readable medium, comprising:
receiving, from a first client device associated with a first requesting user of an online system a first order to be fulfilled by the online system, wherein the order indicates one or more items to be obtained from a first fulfillment location;
identifying one or more order features describing one or more characteristics of the first order;
obtaining one or more location-specific features associated with the first fulfillment location including characteristics describing a parking configuration of the first fulfillment location;
applying a machine-learning model to the order features and the location-specific features to predict a time to park at the first fulfillment location, wherein the machine-learning model is trained by a first process comprising:
obtaining historical orders by requesting users of the online system, each historical order associated with at least one fulfillment location of a plurality of fulfillment locations and a completion time for the historical order,
for each historical order, identifying one or more order features describing one or more characteristics of the historical order,
for each historical order, obtaining one or more location-specific features associated with the fulfillment location of the historical order, and
training the machine-learning model with the order features, the location-specific features, and the completion times for the historical orders;
determining the time to park for the first order is above a threshold;
in response to determining the time to park for the first order is above a threshold, batching the first order with one or more other orders of an in-progress batch being fulfilled at the first fulfillment location; and
updating a graphical user interface, presented on an electronic display of a second client device associated with a first fulfillment user fulfilling the in-progress batch, the in-progress batch of orders to include the first order.

2. The method of claim 1, wherein obtaining the one or more order features comprises extracting the one or more order features from the first including a number of items, an order timestamp, a delivery timeframe, or some combination thereof.

3. The method of claim 1, wherein obtaining the one or more location-specific features associated with the first fulfillment location comprises obtaining the location-specific features including characteristics describing an in-store layout of the first fulfillment location.

4. The method of claim 1, wherein obtaining the one or more location-specific features associated with the first fulfillment location comprises obtaining the location-specific features including characteristics describing order volume at the first fulfillment location.

5. The method of claim 1, wherein obtaining the one or more location-specific features comprises obtaining the characteristics describing the parking configuration from one or more client devices.

6. The method of claim 1, further comprising:
obtaining one or more contextual features describing a context of the first order including availability of fulfillment users.

7. The method of claim 1, wherein applying the machine-learning model comprises applying the machine-learning model to predict a completion time for fulfillment of the first order, and wherein batching the first order with the other orders is further based on the completion time of the first order.

8. The method of claim 1, wherein applying the machine-learning model comprises applying the machine-learning model to predict a set of times to park for different modes of transportation, and wherein batching the first order with the other orders is based on the time to park associated with a mode of transportation of the first fulfillment user.

9. The method of claim 1, the machine-learning model trained by the first process further comprising:
for each historical order, tracking a location of the user during fulfillment of the historical order; and
for each historical order, identifying a portion of the completion time attributable to a parking configuration associated with the fulfillment location of the historical order,
wherein training the machine-learning model comprises training the machine-learning model with the portions of the completion times attributable to the parking configurations associated with the fulfillment locations of the historical orders.

10. The method of claim 1, further comprising:
receiving, from the second client device associated with associated with the first fulfillment user, feedback on the time to park at the first fulfillment location in completion of the first order; and
tuning the machine-learning model based on the feedback.

11. The method of claim 1, wherein batching the first order with the one or more other orders comprises applying a second machine-learning model to a plurality of orders and predicted times to park predicted for the plurality of orders to batch the first order with the one or more other orders.

12. The method of claim 11, wherein the second machine-learning model is trained by a second process comprising:
obtaining historical batches of the historical orders;
for each historical batch, identifying a fulfillment efficiency based on the completion times of the historical orders in the historical batch; and
training the second machine-learning model with the fulfillment efficiencies of the historical batches.

13. The method of claim 1, further comprising:
identifying that the time to park is above a threshold time; and
in response to identifying that the time to park is above the threshold time, triggering a remedial workflow that comprises:
identifying one or more incentives for the batch of orders based in part on the time to park of the first order,
wherein transmitting the batch of orders comprises transmitting the batch of orders with the one or more incentives to the second client device associated with the first fulfillment user.

14. The method of claim 1, further comprising:
identifying that the time to park is above a threshold time; and
in response to identifying that the time to park is above the threshold time, triggering a remedial workflow that comprises:
obtaining a location of the second client device associated with the first fulfillment user,
identifying that the location of the second client device is in proximity to the first fulfillment location, and
in response to identifying that the location of the second client device is in proximity to the first fulfillment location, assigning the batch of orders to the first fulfillment user.

15. A non-transitory computer-readable medium storing instructions that, when executed by a computer processor, cause the computer processor to perform operations comprising:
receiving, from a first client device associated with a first requesting user of an online system a first order to be fulfilled by the online system, wherein the order indicates one or more items to be obtained from a first fulfillment location;
identifying one or more order features describing one or more characteristics of the first order;
obtaining one or more location-specific features associated with the first fulfillment location including characteristics describing a parking configuration of the first fulfillment location;
applying a machine-learning model to the order features and the location-specific features to predict a time to park at the first fulfillment location, wherein the machine-learning model is trained by a first process comprising:
obtaining historical orders by requesting users of the online system, each historical order associated with at least one fulfillment location of a plurality of fulfillment locations and a completion time for the historical order,
for each historical order, identifying one or more order features describing one or more characteristics of the historical order,
for each historical order, obtaining one or more location-specific features associated with the fulfillment location of the historical order, and
training the machine-learning model with the order features, the location-specific features, and the completion times for the historical orders;
determining the time to park for the first order is above a threshold;
in response to determining the time to park for the first order is above a threshold, batching the first order with one or more other orders of an in-progress batch being fulfilled at the first fulfillment location; and
updating a graphical user interface, presented on an electronic display of a second client device associated with a first fulfillment user fulfilling the in-progress batch, the in-progress batch of orders to include the first order.

16. The non-transitory computer-readable storage medium of claim 15, wherein obtaining the one or more location-specific features comprises obtaining the characteristics describing the parking configuration from one or more client devices.

17. The non-transitory computer-readable storage medium of claim 15, wherein applying the machine-learning model comprises applying the machine-learning model to predict a completion time for fulfillment of the first order, and wherein batching the first order with the other orders is further based on the completion time of the first order.

18. The non-transitory computer-readable storage medium of claim 15, wherein applying the machine-learning model comprises applying the machine-learning model to predict a set of times to park for different modes of transportation, and wherein batching the first order with the other orders is based on the time to park associated with a mode of transportation of the first fulfillment user.

19. The non-transitory computer-readable storage medium of claim 15, the operations further comprising:
identifying that the time to park is above a threshold time; and
in response to identifying that the time to park is above the threshold time, triggering a remedial workflow that comprises:
identifying one or more incentives for the batch of orders based in part on the time to park of the first order,
wherein transmitting the batch of orders comprises transmitting the batch of orders with the one or more incentives to the second client device associated with the first fulfillment user.

20. A system comprising:
a computer processor; and
a non-transitory computer-readable storage medium storing instructions that, when executed by the computer processor, cause the computer processor to perform operations comprising:
receiving, from a first client device associated with a first requesting user of an online system a first order to be fulfilled by the online system, wherein the order indicates one or more items to be obtained from a first fulfillment location;
identifying one or more order features describing one or more characteristics of the first order;
obtaining one or more location-specific features associated with the first fulfillment location including characteristics describing a parking configuration of the first fulfillment location;
applying a machine-learning model to the order features and the location-specific features to predict a time to park at the first fulfillment location, wherein the machine-learning model is trained by a first process comprising:
obtaining historical orders by requesting users of the online system, each historical order associated with at least one fulfillment location of a plurality of fulfillment locations and a completion time for the historical order,
for each historical order, identifying one or more order features describing one or more characteristics of the historical order,
for each historical order, obtaining one or more location-specific features associated with the fulfillment location of the historical order, and
training the machine-learning model with the order features, the location-specific features, and the completion times for the historical orders;
determining the time to park for the first order is above a threshold;
in response to determining the time to park for the first order is above a threshold, batching the first order with one or more other orders of an in-progress batch being fulfilled at the first fulfillment location; and
updating a graphical user interface, presented on an electronic display of a second client device associated with a first fulfillment user fulfilling the in-progress batch, the in-progress batch of orders to include the first order.
